(19) United States
(12) Patent Application Publication
(10) Pub. No.: US 2011/0185990 A1
(43) Pub. Date: Aug. 4, 2011

(54) SYSTEM AND METHOD FOR IMPROVING COMBUSTION USING AN ELECTROLYSIS FUEL CELL

(76) Inventor: David Inwald, Franklin, MI (US)

(21) Appl. No.: 13/122,470

(22) PCT Filed: Oct. 2, 2009
(86) PCT No.: PCT/US09/59356

§ 371 Date: Apr. 4, 2011

Related U.S. Application Data
(60) Provisional application No. 61/102,098, filed on Oct. 2, 2008.

(51) Int. Cl. F02B 43/08; F02B 43/10; C25B 9/00; C25B 1/04

(52) U.S. Cl. 123/3; 204/242; 205/628

(57) ABSTRACT

A system for improving combustion including electrolysis means for producing and storing hydrogen and oxygen gases operatively connected to injection means for injecting the hydrogen and oxygen gas into a combustion device. A hydrogen enrichment system. A method of improving combustion by producing and storing hydrogen and oxygen gases, injecting the hydrogen and oxygen gases into a combustion device, and performing combustion. A method of distributing current in an electrolysis system.

### BACKGROUND OF THE INVENTION

1. Technical Field

The present invention generally relates to the field of combustion engines. More specifically, the present invention relates to a system and method for using an electrolysis fuel cell to enhance combustion.

2. Background Art

Utilizing a hydrogen fuel injection system to improve power and efficiency of internal combustion engines has been attempted in the past, however prior methods of fuel injection have proved economically disadvantageous, ineffective, and provide no significant environmental reward.

Basic electrolysis involves two electrodes, the anode and the cathode, submerged in an aqueous solution with an electrolyte. The electrolyte theoretically acts as a catalyst in the electrochemical reaction as it provides a medium for the electrons of the direct current to flow through the water. In actuality, however, very few electrolytes are true catalysts in electrolysis applications. The definition of a catalyst is a chemical substance that increases the rate of a chemical reaction without further altering the reactants or the products.

The most common electrolytes for hydrogen producing fuel cells are the common bases sodium hydroxide (NaOH) and potassium hydroxide (KOH). Both of these electrolytes are strong bases, meaning that their ionic bonds dissociate when dissolved in water. The electrolysis splits the bonds between the hydrogen and oxygen atoms in water. As soon as the oxygen molecules are separated from the hydrogen in the water molecule some of the oxygen molecules then partially bond with the electropositive ions (metals). When the oxygen reacts with these ions, they go through a process which ultimately results in the productions of more water molecules, but limits the amount of oxygen produced in a gaseous form. Theoretically, with an ideal catalyst, for each two units of hydrogen gas produced, one unit of oxygen gas should be produced. By using bases as electrolytes (NaOH, KOH, etc.), the electrolytic cell increases this ratio of hydrogen to oxygen from 3:1 to 4:1, instead of 2:1.

Hydrogen is known to be more explosive in a combustion reaction than oxygen; however, it is a false assumption to take for granted that in an internal or external combustion system that the more hydrogen the better. The present invention utilizes hydrogen and oxygen gas in a 2:1 ratio to improve efficiency for any type of combustion, and preferably direct combustion. In combustion, hydrogen has very unique properties, with the most important being its wide flammability range. At standard temperature and pressure (1 ATM, 273.15 degrees Kelvin), a mixture of hydrogen and air will burn when there is as little as 4 percent hydrogen or as much as 75 percent hydrogen in the mixture. When hydrogen and oxygen gases are mixed together, the flammability range increases further; from as little as 3% to near 99%. Injection systems are commonly scrutinized because it is said that the electrolysis method of hydrogen production yields a non-sufficient amount of gas to make any difference in combustion. The properties of hydrogen and oxygen gases in the mixture as discussed above prove this to be incorrect; because the gases will aide in combustion even when a mere 3% of the gases are mixed with atmospheric gases.

The burning temperature of the gas created proves to be an effective way to calculate the energy content of the gaseous substance. The burning temperature represents the energy content in a given amount of gas. The burning temperature of pure hydrogen is 2318° C. Oxygen burns slightly higher at temperatures climbing past 3000° C. The gases at a 2:1 ratio of hydrogen to oxygen, however, burn at around 5000° C.—much greater energy content than either of the gases alone. This increased amount of energy is precisely why the effect of adding larger quantities of oxygen to hydrogen aids the combustion process. Although burning temperatures of 5000° C. can seem too hot for any common application, temperatures only reach such levels when the gases are burnt in 100%.

In order to ensure an even 2:1 production of hydrogen to oxygen, a true catalyst, one which affects neither the product nor the reactant, must be used. The most readily available electrolyte, sodium chloride (NaCl) fits this profile. Sodium chloride (NaCl), common table salt, is an electrolyte that is neither an acid nor base, and will therefore not affect the atoms of oxygen once they are split from their hydrogen counterparts.

The environmental impact of the adoption of a hydrogen and oxygen fuel injection system is significant. The concept behind fuel injection systems is to more completely combust the given hydrocarbons. In automobiles, for example, gasoline is the hydrocarbon. When the gasoline goes through the current internal combustion system, a certain amount of the hydrocarbon fuel is left over because of incomplete combustion. There are two main reasons incomplete combustion exists. The first source of incomplete combustion is the lack of overall heat in the burning of the fuel. Certain fuels, gasoline for example, require a higher burning temperature than is provided in the combustion chamber of the internal combustion engine. Hydrogen and oxygen gases have a higher burning temperature, and therefore raise the temperature in the combustion chamber for the gasoline. Because of this, the gasoline burns more completely.

The second source of incomplete combustion is found in the lack of oxygen in the combustion chamber. Although the chemical composition of fuel is effected by specific crude oil source, the average amount of oxygen can be calculated for a given amount of gasoline. According to calculations, 7.0032×10⁻⁴ grams of oxygen are needed per gram of gasoline. This means that at standard temperature and pressure, 15.6872 mL of oxygen is needed. It can be assumed that at sea level that 20.95% of the atmospheric gases is pure oxygen. Therefore, when an internal combustion engine is burning a given load of one gram, it is required to have 74.88 mL of atmospheric gases. This number, however, is often times not reached because there is insufficient air in the combustion chamber of the cylinder. This yield yields an incomplete combustion of fuel.

Environmentally, this means that more carbon monoxide, sulfur hexafluoride, and other such gases are released into the environment. In addition, more vaporized gasoline is released into the environment without going through the combustion process, which is the same thing as dumping out a given percentage of gasoline from each tank of gas into the atmosphere.

U.S. Pat. No. 6,257,175 to Mosher et al. discloses an electrolysis unit that generates hydrogen gas and oxygen gas from water and an electrolyte. Mosher attempts to improve the unit's safety by attempting to collect and isolate the generated hydrogen and oxygen gasses. However, additional safety concerns arise upon implementation of Mosher's concept. Injecting pure hydrogen gas into the engine cylinder (as suggested by Mosher) can lead to the hydrogen igniting prematurely, creating an unstable and unsafe situation, known by the automotive community as “knocking,” which exists when any fuel ignites prematurely. Furthermore, in Mosher the method of injection calls for a unique installation of additional parts in the intake manifold of the car, which raises questions about the purpose of the invention.

It is known that vaporized fuel injection systems are beneficial to improved efficiency for a plethora of applications; however, it is anticipated that newer technologies will completely eliminate the need for fossil fuels. As such, fuel injection systems that require a great deal of engine modifications will prove unworthy to consumers. If the cost to purchase an injection system is too great to the consumer, the technology will likely be ignored until the next alternative energies are developed further and made available to consumers. Therefore, it is a priority for current fuel injection systems to be simple enough to be reliable, be easy to install and remove without engine modifications, and be cost effective immediately for the average consumer. Mosher et al. provides a system that requires major modifications to the engine, which defeats a significant purpose of such an invention—namely, economic savings to the consumer. The means of the present invention is designed for easy implementation to provide a path for the alternative energies of the future.

U.S. Pat. No. 6,311,648 to Larocque discloses a hydrogen-oxygen/hydrocarbon fuel system for enhancing the efficiency of an internal combustion engine. One of the significant shortcomings of the Larocque system is that it relies upon gravity to refill the water level inside the electrolytic chamber. In real-world applications involving inclines and turbulent road conditions, it is likely that unintended water will be added to the electrolytic chamber. Since maintaining a precise amount of electrolyte in the system is critical, Larocque's system is not well suited for real-world applications. Furthermore, Larocque does not account for the changing weather conditions which face real-world drivers which could significantly affect the performance of the system.

U.S. Pat. No. 7,143,722 to Ross discloses an electrolysis unit for supplying gaseous fuel additives to enhance combustion in a combustion engine. However, Ross identifies potassium hydroxide (KOH) as the required electrolyte in the system. As described, the use of KOH in Ross' system presents several design defects and problems, among them: the severely corrosive nature of high concentrations of KOH, the inefficiency and wasted electronic resistance that result when using KOH, and the resulting K₂O byproduct produced by the system which is an extremely potent and toxic substance. Furthermore, the injection system described by Ross will likely require a significant amount of time before being able to run at an adequate output, a situation which is impractical for most car drivers.

Other known prior art designs present gas-producing electrochemical fuel cells with various shortcomings. These fuel cells position the anode and cathode plates as close together as possible, resulting in a great amount of energy lost in the form of heat as well as requiring the system to pull through an unnecessary amount of electricity. These older designs cause problems because many of today's cars are not produced with the high-output alternators that other systems may require.

Thus, there remains a significant need for an electrolysis unit for enhancing combustion which overcomes the various shortcomings and disadvantages found in the prior art.

### SUMMARY OF THE INVENTION

The present invention provides for a system for improving combustion including an electrolysis mechanism for producing and storing hydrogen and oxygen gases operatively connected to an injection mechanism for injecting the hydrogen and oxygen gas into a combustion device.

The present invention also provides for a hydrogen enrichment system including at least one production mechanism for producing hydrogen and oxygen operatively connected to a pressure-equalizing unit within an enclosure, and an electronic control mechanism for controlling an amount of hydrogen and oxygen produced.

The present invention provides for a method of improving combustion by producing and storing hydrogen and oxygen gases, injecting the hydrogen and oxygen gases into a combustion device, and performing combustion.

The present invention further provides for a method of distributing current in an electrolysis system by routing power from a current source with an electronic control system, dedicating electricity for external demands, dedicating electricity for hydrogen production, controlling the proportion of hydrogen and oxygen produced, supplying electricity for production of hydrogen and oxygen, producing hydrogen and oxygen at an output chosen from the group consisting of fixed and variable, storing the hydrogen and oxygen, and feeding back results to the electronic control system.

### DESCRIPTION OF THE DRAWINGS

Other advantages of the present invention are readily appreciated as the same becomes better understood by reference to the following detailed description, when considered in connection with the accompanying drawings wherein:

FIG. 1 is a diagram representing the external architecture of the collective enclosure of the present invention;

FIG. 2 is a diagram representing the major components within FIG. 1;

FIG. 3 is a schematic diagram representing the monitoring system, on/off switch as well as main power indication LED;

FIG. 4 is a diagram of the hydrogen and oxygen production unit with a frontal view focusing on the construction of the plates;

FIG. 5 is a diagram of the hydrogen and oxygen production unit with a lateral view;

FIG. 6 is a diagram of the hydrogen and oxygen production unit with an overhead view;

FIG. 7 is a diagram representing the vapor pressure equalizer and storage unit;

FIG. 8 is a schematic diagram representing the flow of water from the main water source to the two components requiring water, the pressure-equalizing unit and the production unit;

FIG. 9A represents the system of the present invention as applied in an external combustion setting, and FIG. 9B represents the means for implementing the air compressor to the main line of tubing in an external combustion setting;

FIG. 10 is a graph representing the relationship between volts and gas output;

FIG. 11 is a graph representing the production of hydrogen and oxygen gases in relation to the distance between plates;

FIG. 12A is an isometric view of a burner, and FIG. 12B is a break-away view of the individual components of the burner;

FIG. 13 is a view of the production unit with a microprocessor and sensor;

FIG. 14 is a view of multiple production units;

FIG. 15 is a flow diagram of a power schematic of the present invention; and

FIG. 16 is view of a single production unit for an internal combustion engine.

### DETAILED DESCRIPTION OF THE INVENTION

The present invention provides generally for a system including an electrolysis unit and a hydrogen-oxygen fuel injection system for improving combustion engines or devices. The present invention also generally provides for a method of improving combustion by producing and storing hydrogen and oxygen gases, injecting the hydrogen and oxygen gases into a combustion device, and performing combustion.

Through electrolysis, hydrogen as well as oxygen gas are produced in quantities directly proportional to the energy input in the form of electricity. In the preferred embodiment, such as an internal combustion engine found in an automobile, the oxygen and hydrogen gases are carried to the air intake manifold where the gases are combined with normal air and injected into the gasoline. Although the main application for the hydrogen-oxygen aided engine is the automobile, the present invention can be applied in any setting where a combustion engine is called for.

Electrolytic cells yield amounts of product that are proportional to the amount of current flowing through solution. This proportionality depends on a correctional constant k. This constant is unique to each cell configuration and depends on a variety of design and application factors. The most significant contributing factor in determining the k value is the configuration of electrodes in the electrolysis units, further described below. Other factors include concentration of electrolyte, volume of reservoir, electrical resistivity of electrodes, and all other design variations that can exist in a uniquely designed electrolysis unit.

The gas output of the electrolysis unit, Oₜₒₜₐₗ, is proportional to the product of the correctional design constant, k, and the time based integral of the current, I, through the cell.

$${O}_{total} ∝ k \cdot {\int }_{0}^{t} I d t .$$

It therefore holds that maximizing the correctional constant is a method of maximizing the output of the electrolysis unit as a whole. Because the constituent factors in formulating k range from design to design, the most effective way to maximize k is experimentally.

The electrolysis unit (100) of the present invention generally includes several components. First, a production unit (14) is included in which, under electrolytic conditions, water molecules are decomposed into their raw elements, hydrogen and oxygen. The hydrogen and oxygen rise to the surface of the production unit (14) in a gaseous form. These gases are then transported to the second main component, a pressure-equalizing unit (15) that also acts as a temporary storage container for the gaseous hydrogen and oxygen prior to injection. A water storage tank (30) contains the water required for both the production unit (14) and the pressure-equalizing unit (15). The gases are then transferred through a given length of tubing (49) to the point of injection into the internal or external combustion. This point of injection varies depending on whether the application utilizes an internal or external system of combustion, as will be explained.

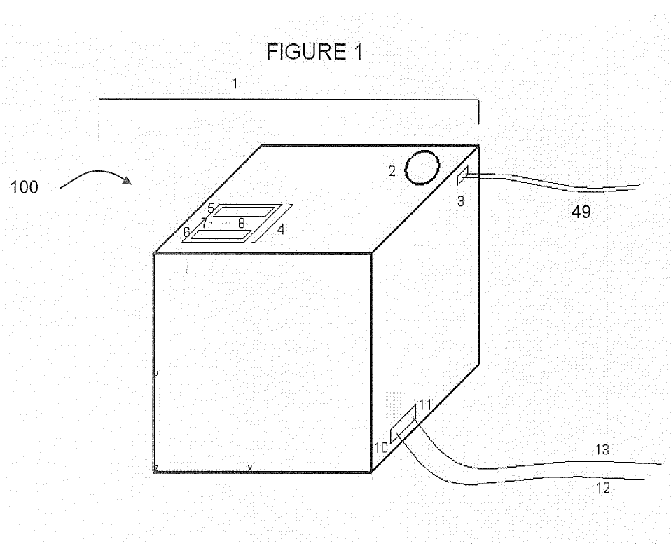

FIG. 1 depicts the external architecture of the main enclosure (1) of the electrolysis unit (100) of the present invention. The main enclosure (1) of the electrolysis unit (100) contains the production unit (14), pressure-equalizing unit (15), water storage tank (30), a hydrogen and oxygen gas mixture outlet (3), as well as a monitoring system (4) that ensures the electrolysis unit (100) is under ideal electrical operating conditions. As shown in FIG. 1, the electrolysis unit is a cube that, preferably, varies slightly in size from a 10″ cube to a 12″ inch cube. Although one set of sizes is listed specifically, the present invention allows for the proportionate enlargement of various components of the electrolysis unit (100) and is neither limited nor restricted to the suggested sizes.

The production unit (14) requires the steady flow of electric current. In the preferred embodiment, the electricity is in the form of direct current of electricity, as opposed to alternating current, because in order for the decomposition of water molecules to occur, a constant flow of electrons is required. In the preferred embodiment, the source of this electrically is most simply provided by the automobiles' readily available electrical system. This electricity is ideally 12 volts, however under normal conditions may range from 11.6 volts-13.8 volts. This difference in voltage creates no profound differences in the operation of the injection system, however the greater the voltages, the more gases will be created.

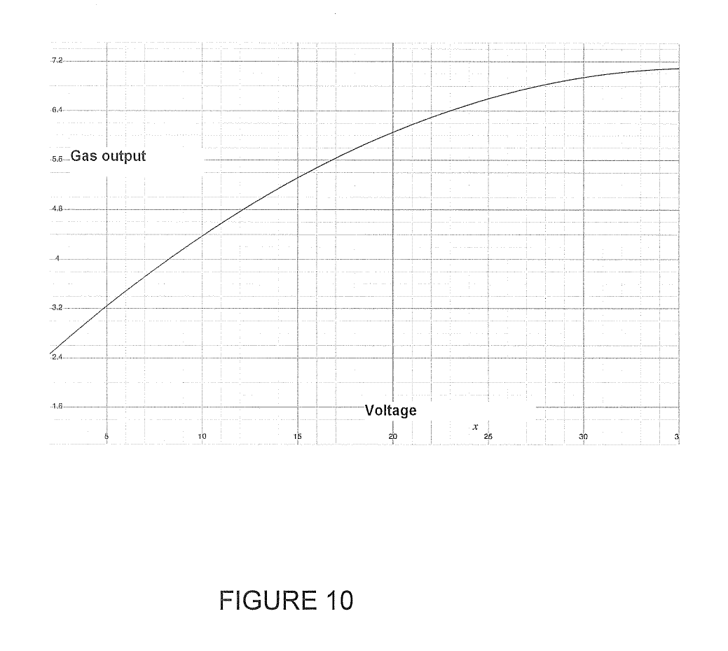

The relationship of volts and gas output can be seen as an exponential equation and is normally observed by the following equation, illustrated in FIG. 10: Gas output=F(v)=−0.003935v2+0.2858196x+1.90996.

As shown in FIG. 10, the production of hydrogen and oxygen gases in an electrolytic cell is estimated by the electrical pressure measured in volts (v) throughout the circuit. This function is applicable to voltages from 2 v-32 v.

FIG. 10 further demonstrates that as voltage increases, the gas output increases as well. Furthermore, as voltage exceeds 30 volts, the slope of the graph (demonstrating the rate of increase of gas output) diminishes significantly. This is precisely why a means of voltage amplification is not utilized. In sum, although a greater voltage will result in a greater amount of hydrogen and oxygen gas in an electrolytic cell, 12 volts plus or minus 3 volts will not dramatically affect the overall means of operation for the system.

Although utilizing the automobile's pre-existing electrical system is simple and effective, in an alternative embodiment the system is configured to utilize DC electric current. With no major modifications to the system of the present invention, the electrical inputs can be sought available from methods such as photovoltaic arrays, isolated regenerative breaking, or reverse solenoid methods such as rear-axel mounted induction turbines as known to those of skill in the art.

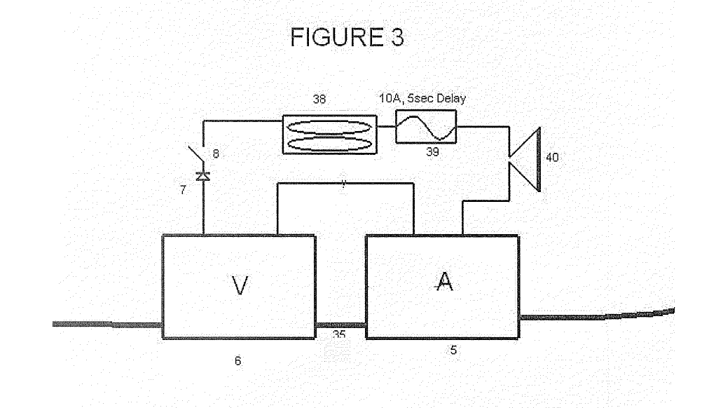

Although under most imaginable operating conditions the system's power consumption remains constant, under extreme environments an electrical monitoring system (4) provides the means to protect the automobile's electrical system as well as ensuring a high level of safety is maintained for the gaseous production unit (14) (depicted in FIG. 3). The electrical monitoring system (4) consists of a voltammeter (6) as well as an ammeter (5). In the preferred embodiment, the monitoring system (4) runs of an external power supply of 3 volts. The circuit to power the digital read-out measurement devices is kept in isolation from the main circuit of the electrolysis unit (100) so to not interfere with the readings. The 3 volt system is designed to run using 2-AA batteries (38), although other adequate 3 volt power supplies can be used.

The voltammeter (6) is preferably of the digital read-out variety and ideally consists of a 4-digit LED display. It is necessary to have a DC voltammeter (6) that displays accurate readings from 0-20 volts, or possibly higher depending on whether an additional main external power source is utilized.

The ammeter (5) is also preferably of the digital read-out variety and ideally consists of a 4-digit LED display. It is necessary to have a DC ammeter (5) that displays accurate readings from 0-20 amperes.

The system includes a master power switch, which is preferably a rocker-type 2-path switch easily accessible to the user. The switch is designed to be active at all times, however power will only be supplied while the engine is under operation. This master power switch is directed towards use as an emergency on-off toggle.

The amperage is the main factor that is important to monitor. If the amperes exceed 10 A, there are two main features this protect the circuit from overloading, depicted in FIG. 3. Initially, the ideal safety mechanism is a time-delay fuse (7, 8). The fuse (7, 8) is designed to break at 10 A, with a 90 second delay. Therefore, if the system regains normal power consumption (under 10 A) the system will continue under normal operation. In addition, primarily in case the time-delay fuse fails to work as designed, an alarm such as a buzzer (40) will activate, in other words, an audible alert mechanism. The buzzer (40) is of sufficient volume so as to be heard by the user. Although other varieties of buzzers (40) can be used, preferably a high-pitched buzzer (40) with intervals of 5 seconds is used. The user can manually use the on-off toggle rocker switch to manually cut power to the system.

The electrical monitoring system (4) of the present invention is designed with automation in mind, requiring no action by the user even if a failure in the system is present, while also incorporating the benefits of having a manual override.

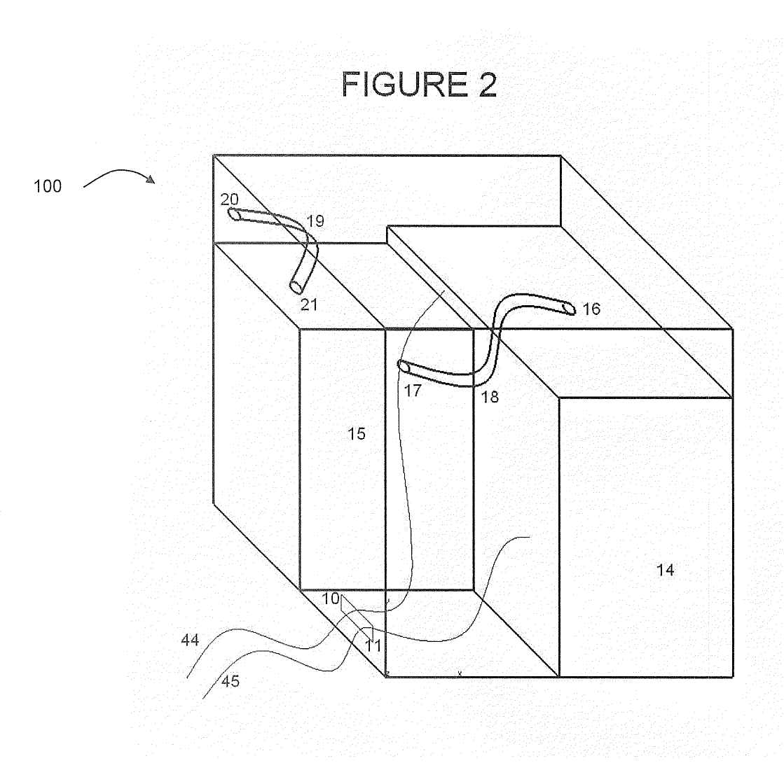

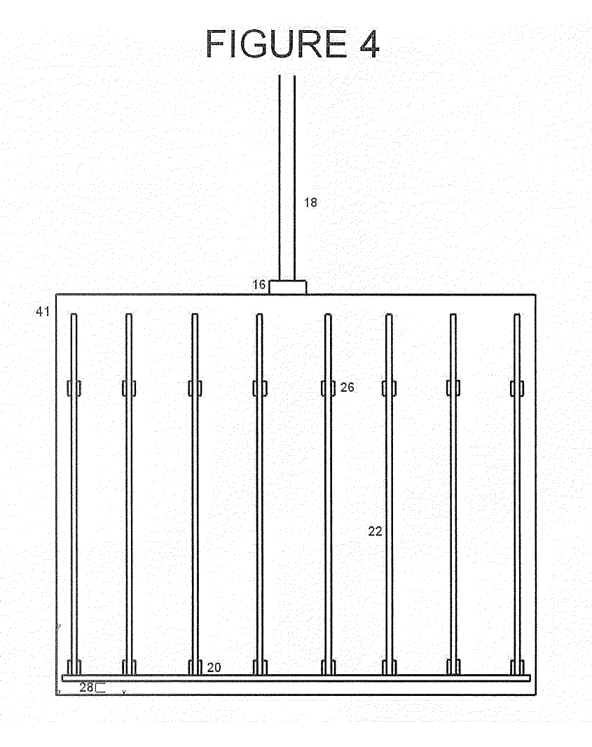

The central component of the present invention is the production unit (14) for producing hydrogen and oxygen gases, as shown in FIG. 2. The production unit (14) contains a given volume of electrolytic solution directly proportionate to the dimensions of the overall cell. FIG. 4 demonstrates a lateral side view of the production unit (14). In the preferred embodiment, the production unit (14) is a rectangular prism consisting of eight electrodes (22) submerged in the electrolytic solution.

Preferably, the electrolyte is based on the anion fluoride. Fluoride is unique because while it has electrolytic properties similar to most other salts, it is electrochemically inert in the described electrolysis unit (100). Fluoride, because of its high elemental electronegativity, does not oxidize and react with the electrodes to produce any other byproducts. Fluoride salts are available with a variety of cations, including ammonium fluoride, potassium fluoride, and sodium fluoride. Properties of these solutions and other fluoride ion solutions differ only slightly, and therefore behave similarly in identical situations. The electrolyte acts as a catalyst to allow the electrochemical reaction to occur, and does not actually take part in the overall chemical reaction. Because the electrolytes are not consumed in the reaction, the electrolyte solution does not need regular maintenance and can withstand extended operating durations without the need to tend to the chemical electrolyte. Alternatively, sodium chloride (NaCl) can be used as the electrolyte as described above.

Preferably, the electrodes (22) are made from pure carbon, especially when a fluoride electrolyte is used. Any carbon-based electrode can be used; however, graphite is the cheapest and most readily available. There are wide varieties of graphite available. The types of graphite differ in chemical purity, surface imperfections, and densities. Electrodes with high-purity and the least surface imperfections are most desirable for operating electrolytic units for extended periods of time. More advanced carbon-based materials are also suitable, such as carbon nanotubes. A higher molecular surface area is key to higher level of efficiency. Platinum is another material that does not react with the fluoride in solution. The electrodes (22) can also be made of a high-grade stainless steel.

In the preferred embodiment, the exact spacing between electrodes (22) is crucial to the overall efficiency of the cell. There are several factors, which affect the spacing between electrodes (22) within the production unit (14):

As the distance between electrodes (22) decreases, amperes increases;

As the distance between electrodes (22) decreases, more heat is given off in the form of water vapor in a linear system of equations; and

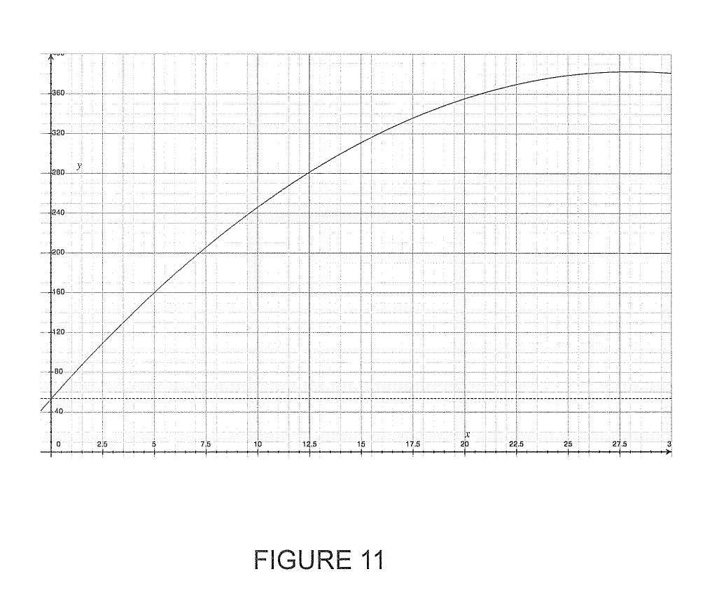

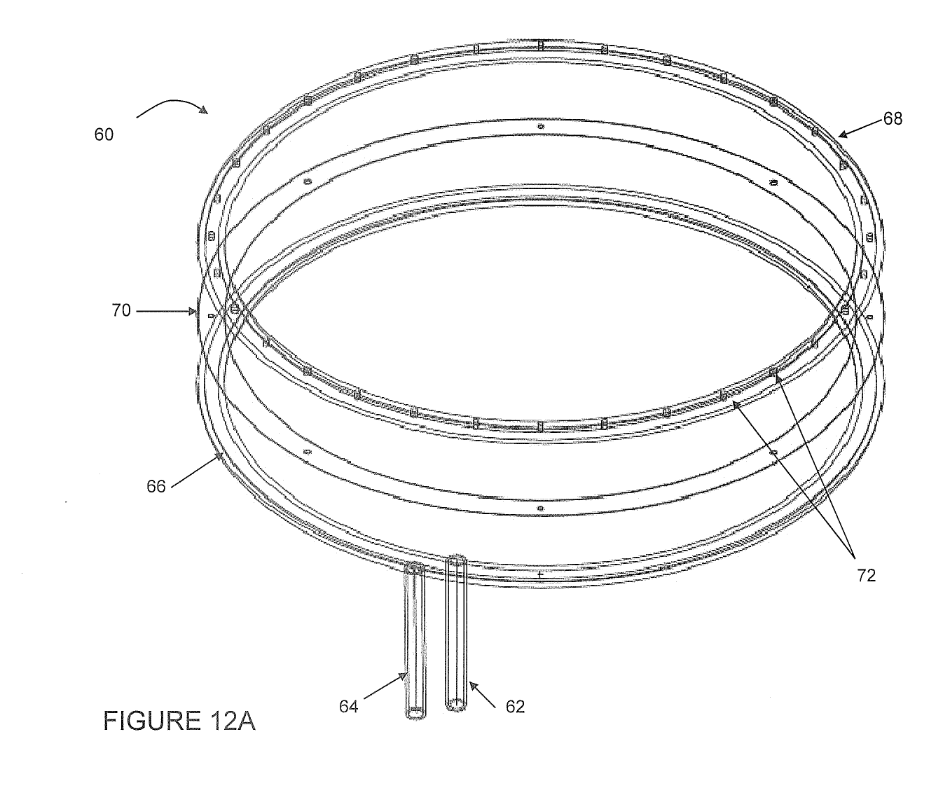

As the distance between electrodes decreases (22), the production of hydrogen and oxygen increases; however, the increase is quadratic and its implications are seen in FIG. 11.

In light of the above, the spacing of the electrodes (22) is crucial as it is important to produce the maximum amount of gas; however, this must be done without pulling through too many amperes and without giving off excess heat.

FIG. 11 shows the production of hydrogen and oxygen gases in relation to the distance between plates. The x-axis represents the spacing, in which each positive integer corresponds to an exact distance. The y-axis is the volume of gases produced in milliliters in a 75 second time interval. The electrodes (22) used were constructed out of 316-stainless steel. The electrolyte was a 0.2 Molar sodium chloride solution.

The data below (Table 1) offers the experimental explanation of the spacing of electrodes (22) in relation to one another. At the distance of 1 inch, the resulting factors reach maximum efficiency. It is at 1 inch that a high level of hydrogen and oxygen gases are produced, yet the amperage remains below 1 amp and the heat (not shown) remains low enough so as to not lose any quantity of water due to water vapor.

TABLE 1

| D | Distance | Output T1 | Output | Output | Average | |
|---|---|---|---|---|---|---|
| Val | (in.) | (mL) | T2 | T3 | (mL) | Amps |
| 1 | 3 | 98 | 98 | 97 | 97.67 | 0.102 |
| 2 | 2.75 | 115 | 111 | 113 | 113 | 0.146 |
| 3 | 2.5 | 128 | 131 | 132 | 130.333 | 0.177 |
| 4 | 2 | 139 | 138 | 139 | 138.67 | 0.208 |
| 5 | 1.75 | 152 | 149 | 153 | 151.33 | 0.214 |
| 6 | 1.5 | 163 | 160 | 160 | 161 | 0.269 |
| 7 | 1.45 | 184 | 183 | 187 | 184.67 | 0.308 |
| 8 | 1.4 | 196 | 195 | 199 | 196.67 | 0.376 |
| 9 | 1.35 | 212 | 214 | 211 | 212.3 | 0.399 |
| 10 | 1.3 | 224 | 227 | 225 | 225.3 | 0.442 |
| 11 | 1.25 | 247 | 245 | 247 | 246.3 | 0.455 |
| 12 | 1.2 | 263 | 269 | 265 | 265.67 | 0.473 |
| 13 | 1.15 | 282 | 281 | 283 | 282 | 0.682 |
| 14 | 1.1 | 311 | 314 | 313 | 312.67 | 0.784 |
| 15 | 1.05 | 333 | 336 | 332 | 333.67 | 0.887 |
| 16 | 1 | 351 | 349 | 348 | 349.3 | 0.987 |
| 17 | 0.95 | 353 | 354 | 357 | 354.67 | 1.221 |
| 18 | 0.9 | 355 | 357 | 354 | 355.3 | 1.379 |
| 19 | 0.85 | 357 | 359 | 359 | 358.3 | 1.947 |
| 20 | 0.8 | 359 | 360 | 360 | 359.67 | 2.441 |
| 21 | 0.75 | 361 | 362 | 359 | 360.67 | 2.908 |
| 22 | 0.7 | 359 | 363 | 362 | 361.3 | 3.436 |
| 23 | 0.65 | 363 | 365 | 362 | 363.3 | 3.79 |
| 24 | 0.6 | 366 | 368 | 369 | 367.67 | 4.005 |
| 25 | 0.55 | 371 | 371 | 372 | 371.3 | 4.238 |
| 26 | 0.5 | 372 | 374 | 373 | 373 | 4.666 |
| 27 | 0.45 | 375 | 377 | 375 | 375.67 | 4.709 |
| 28 | 0.4 | 381 | 382 | 382 | 381.67 | 5.102 |
| 29 | 0.35 | 382 | 383 | 380 | 381.67 | 5.42 |
| 30 | 0.3 | 384 | 383 | 385 | 384 | 5.824 |

The 1-inch spacing is clearly seen in FIG. 4, which is the side view of the production unit (14). In the preferred embodiment, the enclosure (41) is made out of a strong-heat resistant material, preferably molded acrylic or polyvinylchloride, although other materials sharing similar characteristics may be used. From FIG. 4, the elevation of the electrode harnessing system (20, 26) from the bottom surface of the production unit (14) is clearly visible. This raises the electrodes (22) from the bottom of the production unit (14), which allows for the movement of electrolytic solution that is essential during operation on an incline, and for other situations.

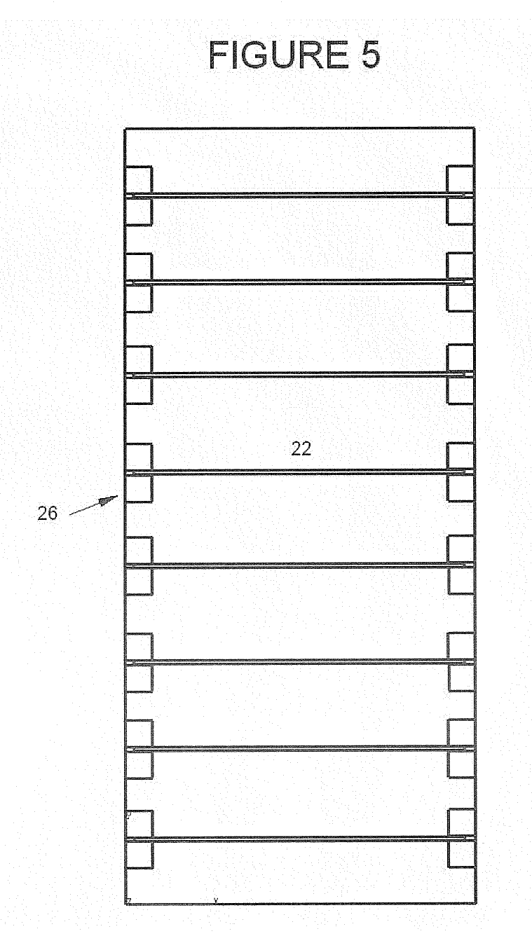

The electrodes (22) are raised off the bottom of the production unit (14) to allow for the even distribution of electrolytic solution and water when the water-feeding ports add water to the production unit (14) (shown at 23). Along each sidewall lays a strip of the material of which the enclosure is constructed (41) that make up part of the electrode harnessing system (20). The strips (20) run the length of the unit and protrude a sufficient length from the side so as to ensure no slippage of electrodes (22). The bottom strip (20) ensures that the electrodes (22) do not move vertically, and the same concept applies horizontally in the unit as well with the grooves (26) perpendicular to the strips 20. The grooves (26) can either protrude from the side or can be negative space, depending on the design of the specific component. In either scenario, the grooves (26) are preferably a distance apart equal to the thickness of electrodes (22). FIG. 5 depicts a lateral view of this arrangement. It is the combination of both the bottom strip (20) and the vertical laying grooves (26) that ensure no movement of the electrodes (22) occurs, even under less-than-ideal conditions.

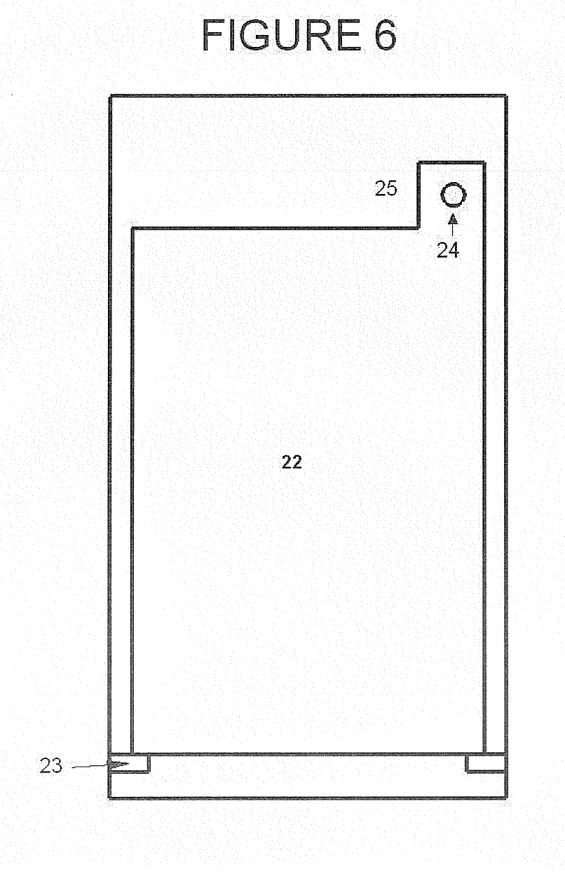

FIG. 6 represents a detailed side profile of the electrode (22) incorporated within the present invention. The strip (20) of material that contains the electrodes (22) vertically is demonstrated from the side view. The electrode (22) includes a notch (25) on the top of the electrode (22) which contains a punched hole (24) which enables a method of electrical combination of charges between like electrodes (22). In the preferred embodiment, the hole (24) is designed to be 0.25 inches in diameter through which connection rods (44, 45) of stainless steel, or a metal of similar conductance, complete the flow of electrons to the other electrodes (22) of a similar charge. There exists one connection rod (44, 45) for each charge present; therefore, two separate fuel connection rods (44, 45) are used. These connection rods (44, 45) are the means through which the electricity from the external power source is introduced to the hydrogen and oxygen production unit (14).

As shown in FIG. 2, the present invention includes wires (10, 11) which are the anode lead (12) and cathode lead (13) which carry the electric current to the production unit (14). In the preferred embodiment, the wires (10, 11) are comprised of insulated copper wiring (12-gauge wire is preferable, however lower-gauge wiring is also sufficient). The wires then connect to the exterior of the cell where the current is continued to the connection rods (44,45). Internally in relation to the outer enclosure; however, externally in relation to the production unit (14) in its entirety, the wires (10, 11) are then connected to the connection rods (44,45) as previously described. These are to be connected by means of a standard electrical terminal with a diameter equal to that of the connection rods (44, 45), 0.25 inches. The production unit (14) is the element in which the hydrogen and oxygen vapors are created from the decomposition reaction of water. As described in detail above, the space between electrodes (22) controls the amount of electricity running through the unit (14), thereby ensuring the system's safe operation. When activated with electricity, the production unit (14) begins to produce the gaseous forms of hydrogen and oxygen gas. As represented in FIG. 4, the gas bubbles rise to the surface of the electrolytic solution where it is fed into the gas transport conduit (16). This conduit (16) transfers the gases from the production unit (14) to the pressure-equalizing unit (15) by means of tubing (18). The conduit (16) can vary in size and diameter, but a secure attachment to the tubing (18) is required so as to avoid any possible leakage of gases from this point. Preferably, the tubing (18) is composed of vinyl; however, polyethylene tubing can also be used. In the preferred embodiment, the tubing (18) at this point has a diameter of ⅜th of an inch.

The diameter of the tubing (18) is critical since wider tubing may not allow the gases to flow to the pressure equalizer. In order for the gases to transfer correctly, a positive pressure must exist in the tubing (18). The wider the tubing (18), the more gas from the production unit (14) is required to force the gases to continue to the pressure-equalizing unit (15). Therefore, the inside diameter of the tubing (18) at this section of the system is preferably ⅜th of an inch.

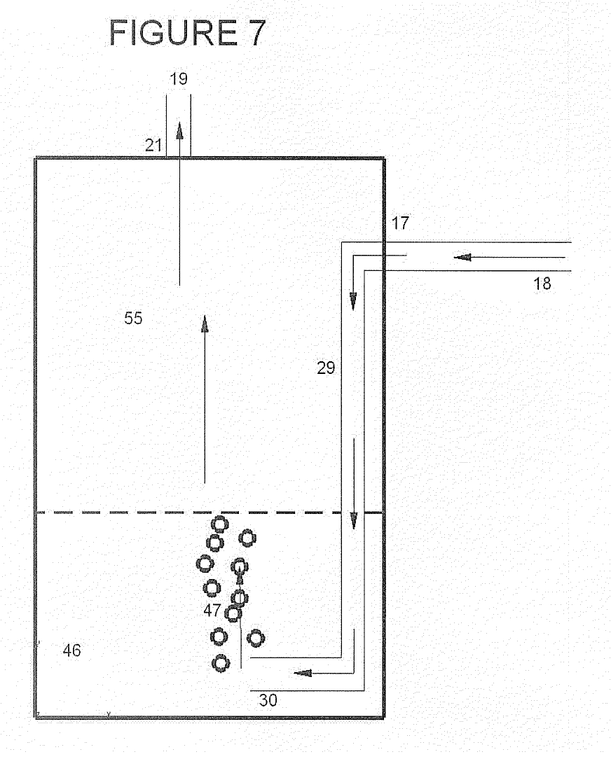

Tubing (18) from the production unit (14) to the pressure-equalizing unit (15) is attached with the same type of connection as used in the gas transport conduit (16), i.e. a pressure-equalizing conduit (17). FIG. 7 depicts the pressure-equalizing unit (15) and storage unit. The pressure-equalizing conduit (17) is preferably located on the side of the pressure-equalizing unit (15), preferably on the top ¼th of the unit. Inside the pressure-equalizing unit (15) lays another set of tubing that is a gas transport conduit (29) connected through the pressure-equalizing conduit (17). This gas transport conduit (29) is constructed of a solid material, such as polyvinylchloride. The gas transport conduit (29) after being attached to the pressure-equalizing conduit (17) then makes a 90-degree turn to continue down to near the bottom of the pressure-equalizing unit (15).

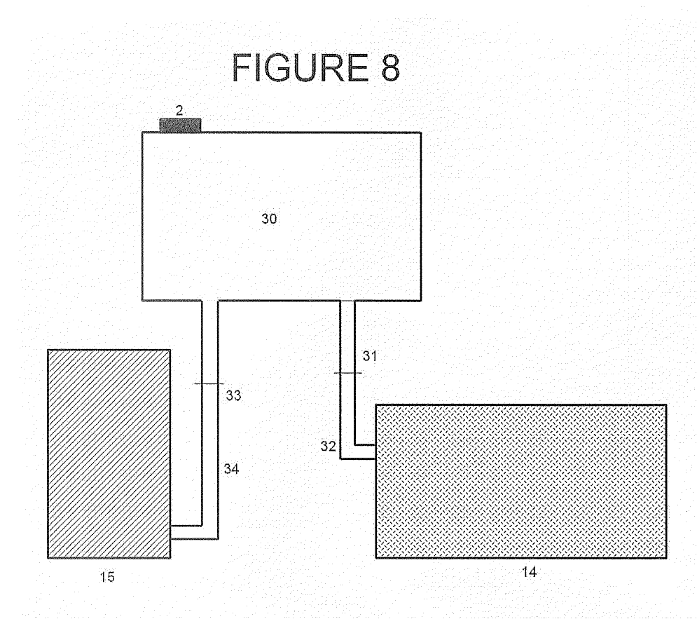

The most important aspect of the pressure-equalizing unit (15) is the water (46) that it contains. The source of the water (46) is the water storage tank (30) shown in FIG. 8. The bottom third of the pressure-equalizing unit (15) contains water. Unlike the production unit (14), this water (46) does not contain an electrolytic solution because no electrochemical reactions occur therein. The purpose of the water (46) is to allow the gaseous hydrogen and oxygen gases to rise from the end of the gas transport conduit to the top of the pressure-equalizing unit. The gases, created in the production unit (14) then flow through the gas transport conduit (29) and bubble up (47) through the water (46). Once the gases bubble through the water (46), they are free to float around in the upper two-thirds (55) of the unit (15). It is in this area (55) the gases remain until demanded by the combustion chamber of the specific application.

It should be noted that the system and method of the present invention is applicable to both internal and external combustion systems. The following description will first illustrate the system's configuration and operation in an internal combustion application, followed by an illustration of an external combustion application of the present invention.

As described previously, all internal combustion engines require a sufficient amount of air in order to carry out the combustion reaction to drive the engine's pistons. Because of this, all internal combustion engines are designed to create negative pressure (a vacuum) to inhale air from an outside source in an attempt to provide the attempted combustion with a certain amount of oxygen. The end result of this process is a strong flow of air from outside of the combustion chamber to the inside. This vacuum is utilized by the present invention to ensure that the proper amounts of gaseous hydrogen and oxygen are injected into the combustion chamber. The present invention utilizes the air-flow already present in the combustion engine together with oxygen sensors to ensure that the proper amount of air is injected. Utilizing the engine's vacuum ensures that there can never be too much hydrogen and oxygen in the injection chamber (which would risk an explosion). The engine sucks in only the amount of air that it requires.

When the engine is demanding air via the negative pressure in the air intake manifold, this creates suction in the tubing (18) from the pressure-equalizing unit (15) to the air intake itself. The suction then makes its way to into the pressure-equalizing unit (15), wherein for each unit of negative pressure that is applied to the pressure-equalizing unit (15), the pressure-equalizing unit (15) releases a given quantity of hydrogen and oxygen through the release conduit (21) to flow through the final length of tubing (19), which feeds directly into the air intake manifold as shown in FIG. 2.

At this point in the process, the hydrogen and oxygen enhance the engine's combustion of the gasoline. The two main factors that control the efficiency of any combustion reaction are the amount of oxygen present in the atmosphere surrounding the combustion and the heat of the combustion. The present invention is directed towards altering both of these factors, thereby improving the efficiency and facilitating a more complete combustion of fuel.

The amount of oxygen joining the gas in the combustion chamber is critical in calculating the efficiency of the combustion. The standard composition of atmospheric gases at sea level is 20.95% oxygen. Calculated from basic stoichiometric calculations, this means that per gram of fuel combusted, the combustion chamber should ideally contain at least 78.436 mL of atmospheric gases. Although this number may be reached at times, there is no guarantee that any volume of atmospheric gases will contain the appropriate amount of oxygen. Therefore, the present invention directly injects oxygen as an additive, to ensure that the oxygen is the excess reactant in the chemical equation. Doing so ensures that the given fuel will not be limited in combustion because of the lack of oxygen. Instead of injecting normal air that requires 78.463 mL of gas, utilizing the system of the present invention requires only a minimal amount of gas to be added to the combustion chamber—a mere 15.6 mL, if pure oxygen is injected. Doing so allows smaller engines to output a greater amount of torque per cubic centimeter (CC) of engine occupancy.

One important aspect of using an internal combustion engine is that the introduction of the gas mixture must be recognized by the original sensors of the internal combustion engine. If the hydrogen and oxygen gas is introduced without adjusting the automated fuel to air ratio computing system, an improper burning ratio will be present, causing adverse effects to the efficiency of the engine, potentially rendering the introduction of hydrogen and oxygen detrimental to the fuel consumption system.

While there is great variation for the technique of injecting the hydrogen and oxygen, there are several requirements that remain constant with the internal combustion engine. The oxygen and hydrogen must mix with the atmospheric gases before reaching the combustion chamber. Alterations to the internal combustion engine's sensing computers must be made to correct for the change in air density. The air density can change dramatically with the introduction of hydrogen because of hydrogen's lighter mass. If changes are not made to the on-board computer or sensor, the internal combustion engine will sense an inaccurately low air intake. This forces more air into the combustion chamber, causing adverse effects for both fuel consumption and environmental impact. The hydrogen and oxygen gases must be drawn into the combustion chamber with vacuum pressure. This allows the gas mixture to be drawn into the system instead of forcefully injected. This allows for the continued use of the onboard internal combustion engine computer.

The second way in which the present invention aids the combustion process is by temporarily raising the heat in the combustion chamber. At times, when too little heat is present in relation to the heat needed for complete combustion for a certain fuel, excess reactants will form. For example, when normal gasoline is burned in a standard automobile, a given amount of carbon dioxide is produced. This carbon dioxide is present because too low a temperature was present in the combustion chamber, ultimately resulting in the production of carbon dioxide gases.

The present invention offers hydrogen as an additive to provide a solution for this source of inefficiency. Hydrogen gas, when in combination with oxygen, has a significantly higher burning temperature than gasoline. Therefore, in a combustion engine when the spark plug provides the spark for combustion, the hydrogen and the oxygen burn at the same time as the gasoline. When the hydrogen and oxygen combust, however, the temperature is raised. In doing so, the higher burning temperatures raise the temperature in the chamber, thereby resulting in a higher level of efficiency for the internal combustion reactions.

The system of the present invention can also be used with external combustion engines, including any other application that burns gaseous fuel to add heat to the system. Although the properties of enhancing combustion remain constant for external combustion reactions, the method of injection differs dramatically. Unlike internal combustion engines, such as in automobiles, external combustion chambers provide very little vacuum pressure. The point of combustion is more open and allows for the natural circulation of air. Therefore, in order to implement the system of the present invention, another source of pressure must be incorporated in order to ensure that sufficient amounts of gaseous hydrogen and oxygen gases are present at the point of combustion.

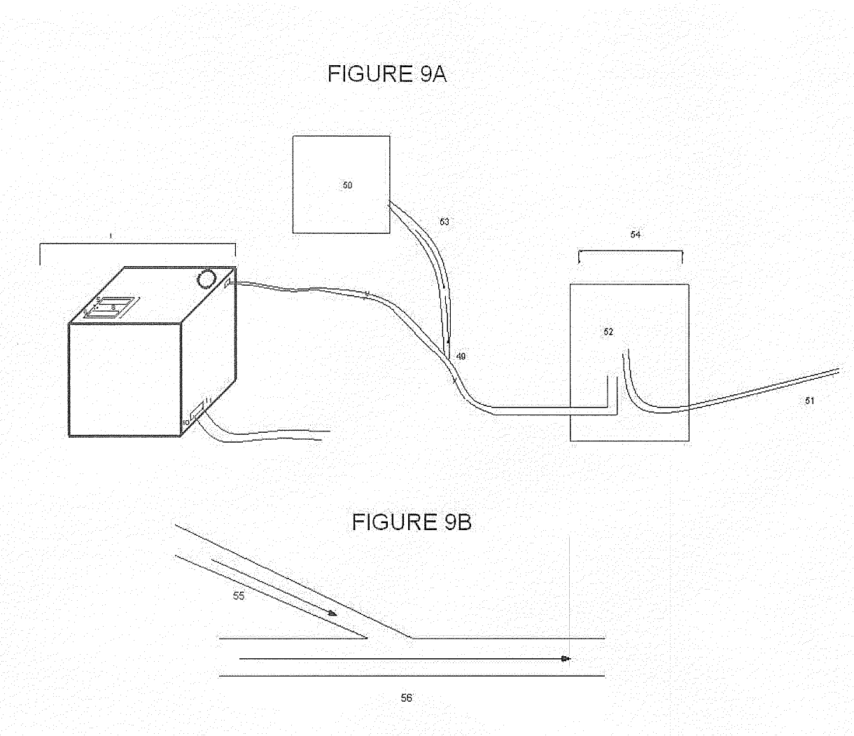

FIG. 9A represents a method of injection for external combustion applications. The production unit (14) is present and remains the most important aspect of the system. After the gas is created in the production unit (14) and travels to the pressure-equalizing unit (15), the gas requires a source of negative pressure, or a vacuum, to be actively injected into the combustion chamber. In the preferred embodiment, this source is a small-scale air compressor (50). The air compressor (50) forces a given amount of atmospheric gases through a gas conduit (53) through the tubing (49) to the point of combustion (52). Alternatively, low-pressure regulators specifically designed for hydrogen gas transfer can be used. If the gases are required to travel longer distances where the pressures are not sufficient to utilize passive regulation mechanisms, pumps can be required. Preferably, this is not the case with the present invention; however, because the gas mixture is produced locally and does not have the travel great distances. When applied to the same tubing as the production unit (14) connects to, vacuum pressure is created. Therefore, the gases are released from the pressure-equalizing unit (15) and sent through the tubing (49) to the external combustion chamber (54). The means for implementing the air compressor (50) to the main line of tubing (49) is shown in detail in FIG. 9B. This demonstrates that the airflow from the air compressor (55) is connected at an angle to the current tubing (56). This ensures that a sufficient amount of gases are drawn from the pressure-equalizing unit (15).

The external combustion chamber (54) contains the key components for any external combustion application. Present is a fuel line (51) which transports the given fuel to the point of combustion (52). Once ignited, the point of combustion (52) maintains a constant flame. When the combustion begins, the user activates the present invention. This begins the production of hydrogen and oxygen gases. The air compressor (50) then creates the vacuum pressure required to transport all necessary hydrogen and oxygen gases to the point of combustion (52). As described above, this aids the combustion by both ensuring proper levels of oxygen and increasing the heat of combustion by the burning of hydrogen gases.

The hydrogen and oxygen fuel mixture can be used to entirely replace the existing combustible fuels for an external combustion system, or can be used in a ratio with existing fuel gases. Burning the hydrogen and oxygen gases alone from other gases (natural gas, propane, etc) results in higher heats in the combustion chambers. For systems that require the heat to be limited, the oxygen and hydrogen can be introduced in conjunction with other fuels to result in a lower burning temperature. Burning the hydrogen and oxygen without the presence of other gases is the most efficient way to use the technology. Furthermore, the combustion of hydrogen and oxygen alone results in water vapor as the only byproduct of the reaction. This water vapor byproduct maintains a high temperature immediately after combustion occurs, and can be utilized in any way that steam is already used.

One of the most common uses for external combustion is in steam heating applications. The combustion of hydrogen and oxygen can be used to provide the heat to convert liquid water to vapor. The efficiency is further increased as the byproduct water vapor can be introduced to the existing steam manifold and delivery system. As the water vapor is utilized to convert the thermal energy to work, the vapor is cooled and condenses to liquid water. This water can then be used to supply the water required by the electrolysis units (100), resulting in a closed system with no wastewater as well as higher levels of thermal efficiency.

As previously mentioned, the system of the present invention includes a method of water distribution to the various components of the injection system. The two units requiring a set amount of water are the production unit (14) and the pressure-equalizing unit (15). In the preferred embodiment, as depicted in FIG. 8, there exists one main tank for the water (30) that is accessible by a removable cap (2). The cap (2) should preferably be child-tamper proof to avoid the possibilities of water leaking. To control the amount of water allowed into each unit, the piping (32, 34) is inserted at a specific distance from the bottom of each respective unit (14, 15). For example, a higher water level is required in the production unit (14) in relation to the pressure-equalizing unit (15), and, therefore, the pipe (32) is inserted at a greater distance from the bottom of the production unit (14) itself. The pipe (34) connecting the water from the main storage tank (30) to the pressure-equalizing unit (15) is at a distance approximately ⅓ from the bottom of the unit. As an added safety precaution, butterfly valves (31, 33) are present on each of the pipes (32, 34) providing water to the various components. Although not readily accessible to the user in the preferred embodiment, in the case of required maintenance or further testing, the valves (31,33) can provide the means necessary to precisely control the amount of water flow.

The system of the present invention can further include a computing system. There are two main purposes for the computing system; live safety monitoring, and live optimization adjustments. An additional benefit of the computing system is to receive data to a main data hub via a live webserver connection, further discussed below. This wealth of data is used for a broad range of optimization and calibration efforts for any.

The computing system includes a low-power microprocessor (74) and a variety of sensors (76). The sensors (76) are specific to the application, however certain sensors (76) are consistent through all applications: temperature sensors, pressure sensors, voltmeters, ammeters, and a UV light sensor. The microprocessor (74) can also include a fuse (39) with or instead of digital current controls, and the fuse (39) can be connected to the main wiring shown in FIG. 3.

Although a copy of the data is sent to the webserver, local copies of data are stored temporarily. As the data is collected, the computing system runs an algorithm calculating hydrogen and oxygen gas outputs. These results are then compared to the optimized results to see if the system must make any changes. If required, the microprocessor is equipped to actuate different control outputs for optimization.

The main benefit of adding an on-board computer for the system is the added safety. This computing system is capable of immediately detecting any leaks or other potentially dangerous situations. The computing system has full capabilities to cut power to the production unit (14) as well as activating a solenoid that disrupts the central tubing (49) continuity. The computing system can be added to any of the parts of the present invention as necessary.

The complexity of the computing system varies depending on the desired system. The computing systems are embedded within the production units (14) themselves, and are user controlled via an electronic control system (ECS). The ECS varies in appearance and functionality depending on the application. Automobiles, for example, have a simple ECS that allows only for basic system functions. This is because automobiles operate with one production unit (14) and therefore do not have many user controls.

More complex systems that utilize many production units (14) have an ECS with accordingly more options. The ECS for these complex systems have the ability to control all aspects of the functionality of the system as a whole. This includes a variable output system, variable input, and any specific controls that can be required depending on the application.

In conjunction with the computing system described, a web server is used to compile a master set of usage data. This connection can be maintained via Bluetooth, Wi-Fi, or Ethernet connections. Each unit uploads to its own database, a continually updated XML directory containing output data from sensors described in the computing system. The webserver has connections with both the ECS and the embedded microprocessors in the production units (14). While the connections between the two types of computers are traditionally hard-wired, they both have the capabilities to communicate wirelessly, offering the ability to be controlled off-site.

The modularity of the system is critical to its usability. Local “on-location” hydrogen demand varies like any combustible fuel. Therefore, the system must be able to variably produce hydrogen, instead of at a constant rate which enables the possibility for large amounts stored at one point, or on the opposite end, a shortage. Both cases can be extremely detrimental, depending on the application.

The desired output (and other functional variations) is controlled by the electronic control system (ECS) in conjunction with the microprocessors in the production units (14). The ECS is the user interface and means for power distribution that communicates with the microprocessors in the individual production units (14). There are two main ways the system can limit (more precisely control, because it can also increase production) hydrogen production. First the system can power on/off entire electrolysis units. Some applications have only one production unit (14). For higher output systems that have multiple production units (14), the system can at any time shut off or turn on any number of units (14). Because the reaction is electrically dependant, output ceases/initiates almost instantaneously. With the electrolyte and electrode chemical compositions described herein, the production units (14) do not suffer adverse effects from either extended time periods of operation, or periods of inaction. Second, conditions can be controlled within the activated production units (14). Output can be adjusted without entirely powering on or off the production units (14). Max current can be seamlessly limited to an individual production unit (14). Because output for each production unit (14) is proportional to current, this is an effective means to limit output. Limiting current is the easiest way to adjust output for the individual production unit (14); however, it can also be achieved by altering the electrolyte concentration, operating temperature, and more factors.

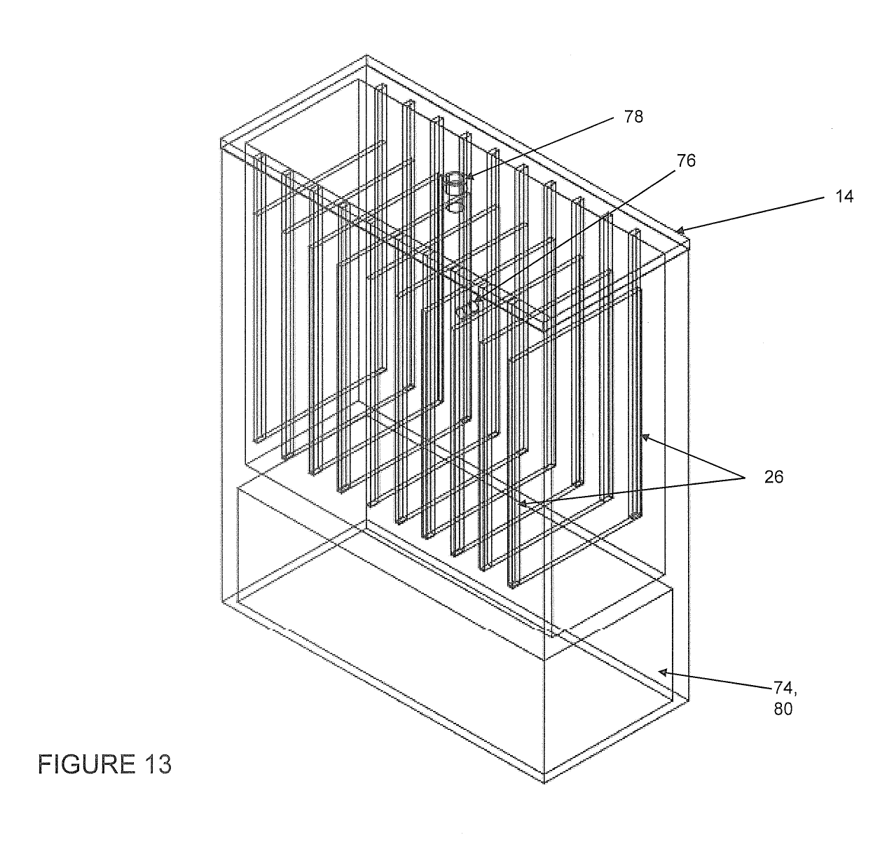

FIG. 13 shows an example of the production unit (14) including a microprocessor (74) and sensors (76). This particular production unit (14) is designed with modularity in mind because it can be used in systems that require multiple production units (14). A gas outlet valve (78) can be included so that gases produced by the electrolysis can escape before use. This valve (78) is beneficial to be of a type used for the typical handling of hydrogen. A specialized hydrogen valve (78) can reduce the amount of gases that escape the electrolysis unit at connection points. Electrode harnesses (grooves) (26) hold the electrodes (22) in place and supply the electrical connection. There are preferably ten graphite electrodes (22) that are suspended above the bottom surface of the reservoir as to allow for uninhibited flow of electrolyte solution throughout the container. The microprocessor (74) is located in an under mount space (80). The microprocessor (74) fits within the volume ceilinged by the bottom surface of the electrolyte reservoir. The microprocessor (74) is equipped with a variety of sensors (76) that are distributed throughout the production unit (14). This space allows for the wiring of such components while keeping the design fully modular. The quantity and variety of sensors (76) within the production unit (14) depends on the application for the system as whole. For example, a pressure sensor (76) is shown that can play a critical role in the functionality of the computing system and the present invention as a whole. A hole can be included to allow the sensor (76) to collect data within the production unit (14).

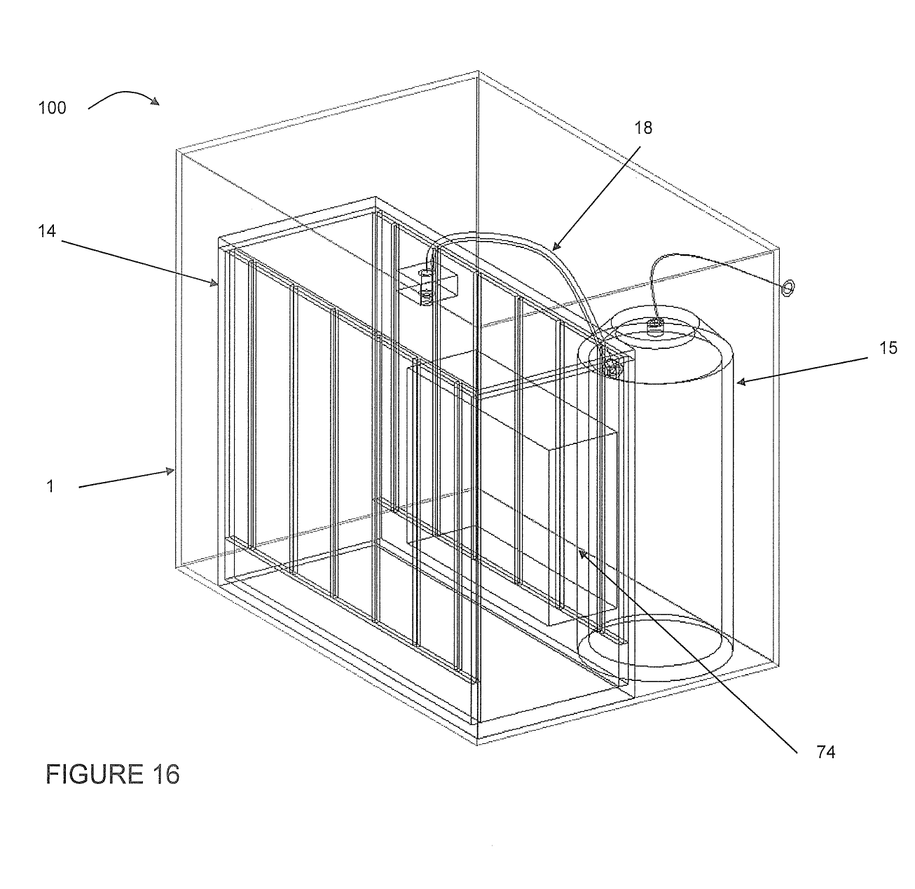

A single production unit (14) can also be used as shown in FIG. 16 generally for injection in an internal combustion engine. The parts are essentially as described above. The engine pulls a vacuum pressure at the main mixture output, which creates a perfectly constant gas flow to the engine from the pressure-equalizing unit (15). In this situation, the microprocessor (74) at the very least handles the production of hydrogen and oxygen inside the production unit (14). For many applications, this is also used to monitor/control the end result as well. There needs to be constant pressure through the tubing (18) from the production unit (14) to the pressure-equalizing unit (15). Furthermore, this pressure needs to be greater in magnitude than the magnitude of vacuum pressure, otherwise no gas mixture can be supplied to the engine.

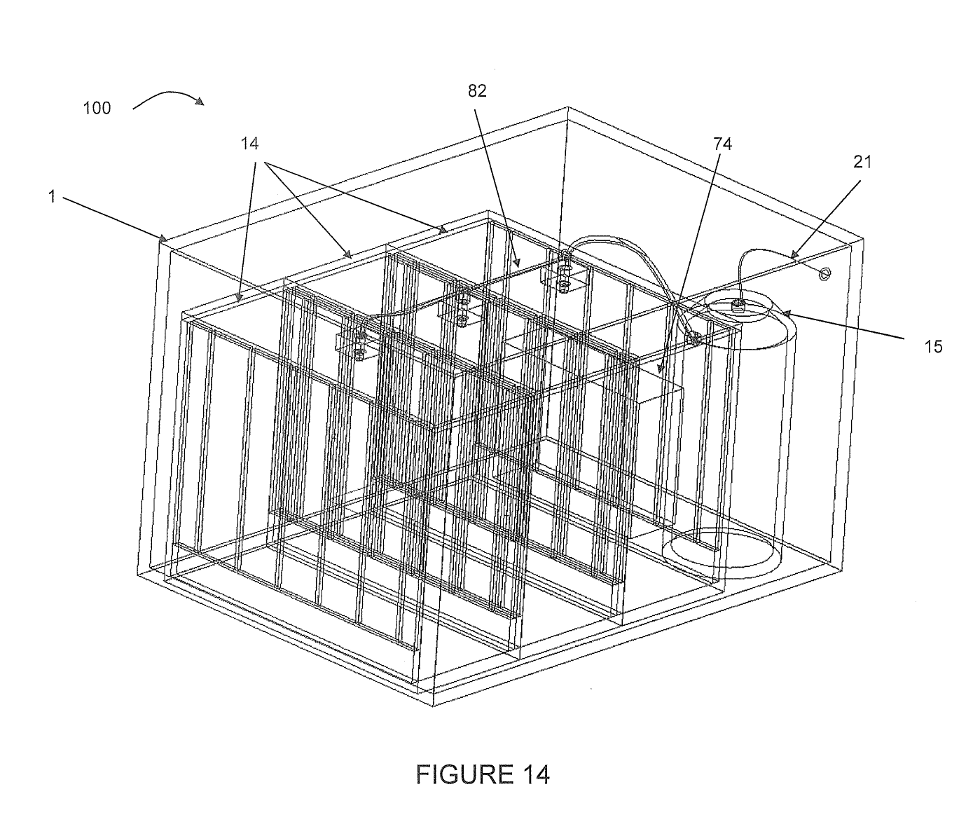

Multiple production units (14) can be used as shown in FIG. 14. Three production units (14) are shown combined with a single pressure-equalizing unit (15) within an enclosure (1). All of the production units (14) are controlled by the ECS that includes microprocessor (74). At least one conjunction manifold (82) is included in this design so that the produced gases from all three production units (14) gather prior to flowing to the pressure-equalizing unit (15). This is to ensure additional safety because of the greater potential for a build up of pressure with multiple production units (14). The production units (14) are easily joined with the conjunction manifolds (80). The combined hydrogen and oxygen output for the three production units (14) flows through the release conduit (21) through the final length of tubing (19) as described above as an outlet.

Another way multiple production units (14) can be used together in a joint system is if their gas outputs are directed towards different uses. In this case, they are still operating under the same current source, but have separate production and injection details. Like fuel cells, the present invention's production units (14) can be stackable, and banks of production units (14) for larger volume hydrogen and oxygen output are a great utilization of the technology.

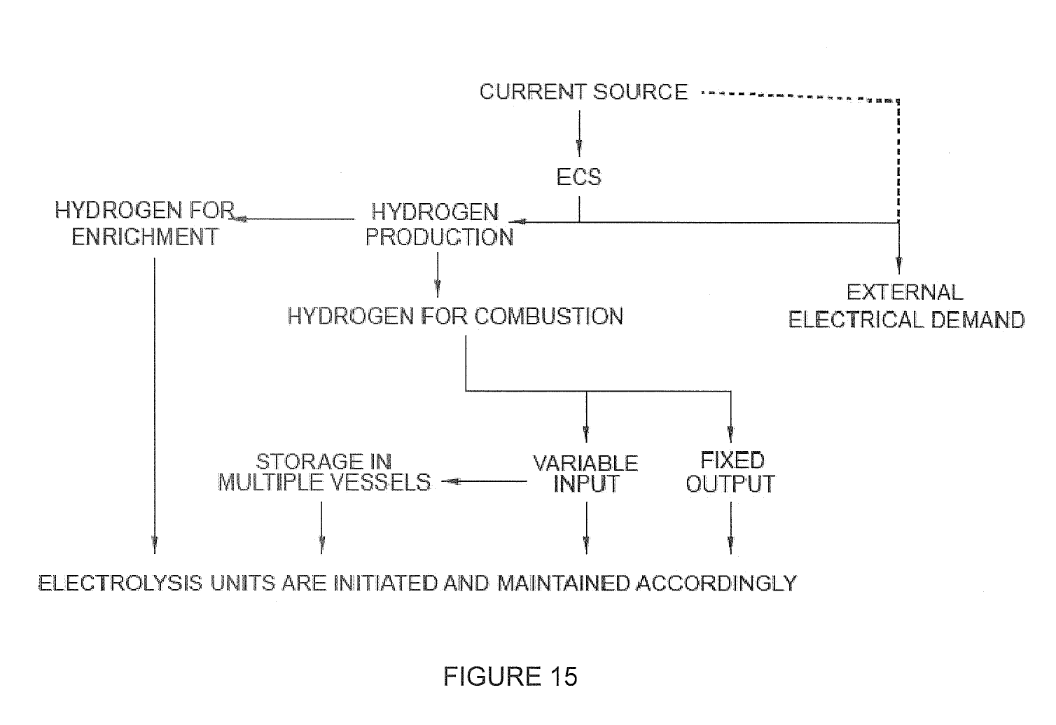

FIG. 15 shows a flow diagram of the distribution of current from the initial power source as it is allocated through the ECS. Starting at the current source, this is the source of electrical energy that the system requires. Ideally the source is renewable, resulting in a carbon neutral footprint. In automobiles the current source is at the least the alternator, and is more efficient with the addition of other renewable sources of electric current. Non-automotive applications can have more than one current source (feed from batteries, solar panels, wind turbines, etc) and this current source is the combined power from these sources.

The ECS, as described above, is the user interface where any possible system configurations are accessible. Because a major application for the present invention is for off-grid systems, the ECS can also be used to route power to any other devices requiring electrical energy. For hydrogen production in systems using one production unit (14), the ECS can be as simple as a switch. For systems that have multiple production units (14), the ECS is responsible for communications between the production units (14).

As the ECS also functions as an overall power distributor, a certain amount of power can be required for external demands. This amount of electrical energy dedicated to external demands is user defined, and can vary with time or load factors. For example, if a system utilizes solar panels that outputs 500 watts and there is a need to supply 200 watts to other electrical devices, the remaining current will be managed by the ECS to deliver power most efficiently to the production units (14).

Electricity is then dedicated for hydrogen production. The total available power is dedicated to producing the mixture of hydrogen and oxygen. Quantifiably, this is the total current subtracted by the total current required by external sources.

Controls on the ECS allow for the production of oxygen and/or hydrogen for chemical enrichment processes. When desired, the ECS can be utilized to change the proportions at which the oxygen and hydrogen are produced. These precise ratios allow the gases to be utilized in forms other than combustion.

Next, the amount of current is allocated towards supplying power to the production units (14). Within each production unit (14), power is supplied to the microprocessor (74) as well as the electrodes (22) that create the potential difference required for the electrochemical reaction to occur.

The fixed output is for use where a specific flow rate of the combustible gas mixture is required. This user-defined value can be in units of flow rate, potential combusted energy output, mass of gas mixture, etc. The ECS has controls that can provide a constant gas output. The ECS is responsible for allocating power across multiple production units (14), and receives live data from microprocessors (74) within, representing the operating conditions within each part of the system.

Certain applications call for the maximum amount of gases to be produced for any variable power input. This can be a solar panel which directly supplies time-varying current, at which point the ECS distributes power to the production units (14) in a manor to produce the largest amount of combustible fuel.

In general, the system is not designed for long-term storage or transport of the hydrogen and oxygen gas mixture. When user activated, the ECS directs the gas flow to a given reservoir at low pressure. When the maximum or designed pressure is achieved, the ECS automatically stops flow into the according vessel.

The end result of any desired option of this power distribution schematic is the ECS communicating with the microprocessors (74) in each production unit (74) to achieve the desired results.

One of the main benefits of the present invention compared to current leading hydrogen technologies, is the low pressure nature of the system. Instead of storage vessels containing hydrogen at above 500 psi, the present invention keeps the pressure of combustible gases at or near atmospheric pressure conditions. This has dramatic results on the applications of the technology as a whole. Hydrogen storage and transport technologies are still limiting the progress of utilizing hydrogen as an energy source. High pressure hydrogen systems have an increased amount of “waste hydrogen”: hydrogen that is unused because it is lost in the storage and transportation steps.

The present invention combusts the hydrogen near the rate of production. This concept, unseen in hydrogen combustion technologies, allows for hydrogen production units for any size or scale application. Because the present invention is effective even at small scale, major infrastructure is not required for the initial implementation of the technology.

While at low pressures, the hydrogen is easily transported to temporary storage vessels from which the gases are transported for combustion or enrichment applications. After the hydrogen vacates the production unit (14) where it is produced, is it transported via tubing (18) to the temporary storage vessel of the pressure-equalizing unit (15). The positive pressure of the gases being produced from the electrolysis unit (100) are the only motive forces for the gas mixture at this point.

The present invention can also be used more generally as a hydrogen enrichment system. Combusting hydrogen with the oxygen is not always the best way to utilize the hydrogen. Because of hydrogen's unique chemical properties, it is used in the enrichment of other fuels. Biofuels are a perfect example where the chemical enrichment process using hydrogen adds to the effectiveness of the fuel. For varieties of applications where the hydrogen is chemically used precombustion, the desired ratio between the hydrogen and oxygen can be different than what is required for combustion. Therefore, the electronic control unit has the ability to change these proportions. The method of hydrogen enrichment varies greatly depending on the chemical compounds or mixtures being enriched. Once the gas mixture is collected, any standard means of enrichment can be used.

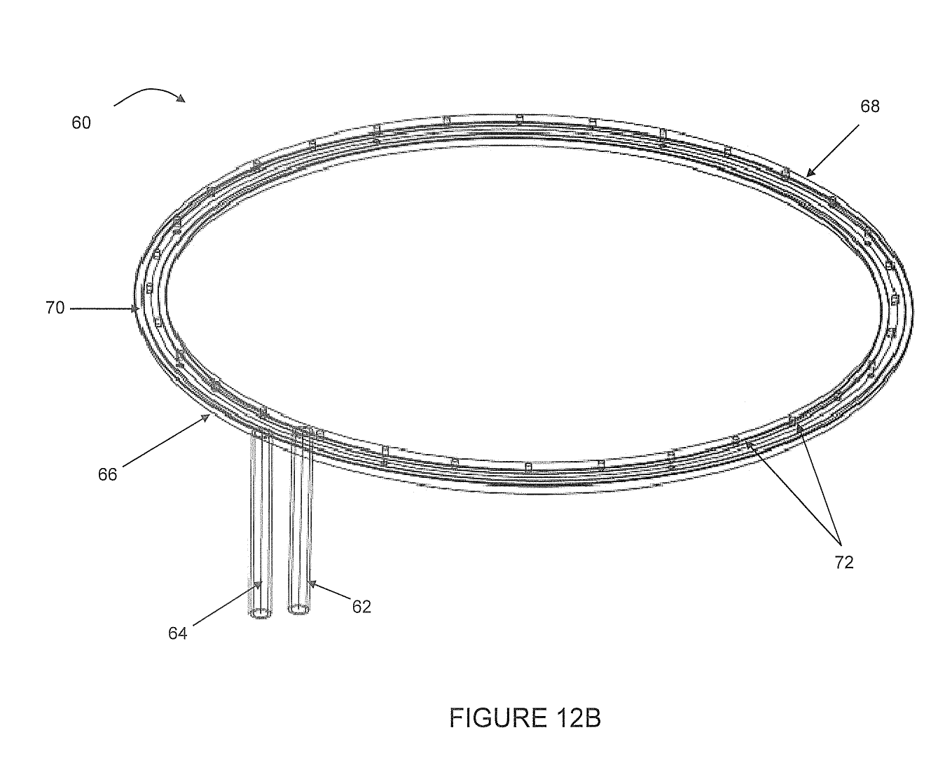

The present invention can be used in combination with a dual gas burner 60, shown generally in FIGS. 12A-12B. In general, the term “dual gas burner,” refers to an apparatus designed to combust a primary fuel source (hydrocarbon fuel-fossil fuel) in the presence of a secondary fuel source. The secondary fuel source in the case of the present invention is mixture of hydrogen and oxygen gases produced from the electrolysis units (100). Any device that burns a hydrogen carbon fuel utilizing a burner can easily be adapted to burn with the additional presence of hydrogen and oxygen gases. This can be achieved in many ways; however, a simple design is shown in FIGS. 12A-12B.

The dual gas burner 60 includes a primary gas manifold 62 that is used to introduce the primary (hydrocarbon) gas into the top (primary) sectional fuel rail (68), as well as a secondary gas manifold 64 where a regulated hydrogen and oxygen mixture is introduced to the bottom (secondary) fuel rail 66 in the dual gas burner 60. A gas membrane 70 separates the primary gas from the secondary gas, and its properties vary depending on the composition of gases. Once in the secondary fuel rail 66, the secondary gas passes the gas membrane 70 to combine with the primary gas before combustion occurs. After the gases are premixed in the primary fuel rail 68, they escape together through combustion points 72 (i.e. the ignition points for the burner), which are essentially holes in the top of the primary fuel rail 68.

Most commonly, these types of burners 60 combust conventional natural gas or propane. The efficiency of these burners 60 can be increased by the addition of the hydrogen and oxygen gas mixture produced by the present invention.

The addition of hydrogen and oxygen into the combustion of fuels helps in several main ways. First, the addition of combustible hydrogen adds heat to the system. Hydrogen in the presence of oxygen burns at much higher temperatures than do hydrocarbon fuels. In addition, the high flame propagation properties of combusting hydrogen aid the complete combustion of the fossil fuels. Therefore, with the addition of hydrogen and oxygen to a fossil fuel burner there is a much greater energy output. Furthermore, because the hydrogen recombines into water vapor when combusted, and hydrogen's flame propagation results in a more complete combustion of the fossil fuels, the overall toxic and greenhouse gases are dramatically lowered.

Dual gas burners 60 can be used in countless applications. Steam boilers, for example, are effective use of this technology. Dual gas burners 60 can be safely used for cooking because of its clean burning nature. The food industry has a need for this technology, as it can offer extremely high temperatures with an even heat distribution through space (as applied to a closed oven, for example).

The ratio between the size of the primary 68 and secondary fuel rails 66 and the permittivity of the gas membrane 70 depends on type of hydrocarbon fuel applied. The individual flow rate regulation of the primary and secondary gases is an easy method to change the properties of the flame produced in the combustion reaction. Once calibrated, the dual gas burner 60 as described can be automated utilizing the electronic control system (ECS). A desired heat output from the burner 60 can be controlled and monitored via the ECS.

The above presents a method for burning the hydrogen and oxygen mixture with another primary fuel source. Another option for the combustion of the hydrogen and oxygen mixture is a hydrogen gas burner as described by Stanley Meyer in U.S. Pat. No. 4,421,474. This is an effective way to combust the mixture.

The invention has been described in an illustrative manner, and it is to be understood that the terminology that has been used is intended to be in the nature of words of description rather than of limitation.

Obviously, many modifications and variations of the present invention are possible in light of the above teachings. It is, therefore, to be understood that within the scope of the described invention, the invention may be practiced otherwise than as specifically described.

What is claimed is:

1. A system for improving combustion comprising:
electrolysis means for producing and storing hydrogen and oxygen gases operatively connected to injection means for injecting said hydrogen and oxygen gas into a combustion device.

2. The system of claim 1, wherein said electrolysis means is further defined as at least one production unit operatively connected to a pressure-equalizing unit within an enclosure.

3. The system of claim 2, further including a water storage tank operatively connected to said production unit and said pressure-equalizing unit.

4. The system of claim 3, wherein said water storage tank includes pipe means for controlling an amount of water allowed into said production unit and said pressure-equalizing unit.

5. The system of claim 4, wherein said water storage tank includes a cap and valve means for controlling water flow.

6. The system of claim 3, further including monitoring means for ensuring ideal operation of said electrolysis means.

7. The system of claim 6, wherein said monitoring means includes a voltammeter and ammeter with displays.

8. The system of claim 7, further including a time-delay fuse that breaks at 10 A with a 90 second delay.

9. The system of claim 8, further including an audible alert mechanism.

10. The system of claim 6, further including electric current means for supplying electric current to said production unit.

11. The system of claim 10, wherein said electric current means is an electrical system of an automobile.

12. The system of claim 10, wherein said electric current means is DC current.

13. The system of claim 10, further including a master power switch.

14. The system of claim 13, wherein said production unit includes electrodes submerged in an electrolytic solution including water.

15. The system of claim 14, wherein said electrolytic solution is chosen from the group consisting of a solution including fluoride anion and a sodium chloride solution.

16. The system of claim 14, wherein said electrodes are made of a material chosen from the group consisting of a pure carbon composition, graphite, carbon nanotubes, platinum, stainless steel.

17. The system of claim 14, wherein said electrodes are spaced one inch apart from one another.

18. The system of claim 14, wherein said electrodes are elevated with an electrode harnessing system from a bottom portion of said production unit.

19. The system of claim 18, wherein said electrode harnessing system includes strip means for preventing vertical movement of said electrodes and groove means for preventing horizontal movement of said electrodes.

20. The system of claim 18, further including connection means for completing the flow of electrons to electrodes or a similar charge and for providing electricity to said production unit.

21. The system of claim 14, wherein said production unit further including a gas transport conduit operatively connected to tubing that is operatively connected to said pressure-equalizing unit with a pressure-equalizing conduit.

22. The system of claim 21, wherein said tubing has a diameter of ⅜th of an inch.

23. The system of claim 21, wherein said pressure-equalizing unit further includes a gas transport conduit that empties in a bottom portion of said pressure-equalizing unit.

24. The system of claim 21, wherein a bottom third of said pressure-equalizing unit contains water from said water storage tank, and an upper third contains said gases created in said production unit.

25. The system of claim 2, wherein said injection means further includes negative pressure means for creating suction in the pressure-equalizing unit.

26. The system of claim 25, wherein said injection means are operatively connected to an internal combustion engine and said negative pressure means is an air intake manifold.

27. The system of claim 25, wherein said injection means are operatively connected to an external combustion engine and said negative pressure means is an air compressor.

28. The system of claim 27, wherein said external combustion engine is part of a steam heating device.

29. The system of claim 2, wherein said injection means are operatively connected to a dual gas burner.

30. The system of claim 29, wherein said dual gas burner includes a primary gas manifold operatively connected to a primary fuel rail, and a secondary gas manifold operatively connected to said injection means and to secondary fuel rail, wherein a gas membrane operatively connects said primary fuel rail and secondary fuel rail, and said primary fuel rail further including combustions points.

31. The system of claim 2, further including a computing system having a microprocessor and at least one sensor.

32. The system of claim 31, wherein said sensor is chosen from the group consisting of a temperature sensor, a pressure sensor, a voltammeter, an ammeter, and a UV light sensor.

33. The system of claim 31, wherein said microprocessor at least temporarily stores data of hydrogen and gas outputs.

34. The system of claim 33, further including data transmission means for transmitting data collected by said microprocessor to a webserver.

35. The system of claim 34, wherein said data transmission means are chosen from the group consisting of hard-wired, Bluetooth, Wi-Fi, and Ethernet connections.

36. The system of claim 34, wherein said computing system is operatively connected to said production unit.

37. The system of claim 36, further including electronic control means for user operation of said computing system.

38. The system of claim 2, wherein said electrolysis means is further defined as at least two production units operatively connected to each other by at least one conjunction manifold, said conjunction manifold being operatively connected to said pressure-equalizing unit.

39. The system of claim 38, wherein said production units are stackable.

40. A hydrogen enrichment system, comprising at least one production means for producing hydrogen and oxygen operatively connected to a pressure-equalizing unit within an enclosure, and electronic control means for controlling an amount of hydrogen and oxygen produced.

41. A method of improving combustion, including the steps of:
producing and storing hydrogen and oxygen gases;
injecting the hydrogen and oxygen gases into a combustion device; and
performing combustion.

42. The method of claim 41, wherein said producing step is further defined as electrolyzing a solution including water in at least one production unit and producing hydrogen and oxygen gases.

43. The method of claim 42, wherein the solution is chosen a solution including fluoride anion and a sodium chloride solution.

44. The method of claim 42, further including the step of providing electricity to perform said electrolyzing step.

45. The method of claim 44, wherein said providing step is further defined as providing electricity from a source chosen from the group consisting of an automobile electrical system and DC current.

46. The method of claim 42, further including the step of preventing movement of electrodes and maintaining the electrodes above a bottom portion of the production unit.

47. The method of claim 42, further including the step of monitoring and displaying operating conditions of the electrolyzing step.

48. The method of claim 41, further including the step of breaking a circuit when amperage is exceeded.

49. The method of claim 48, further including the step of activating an alarm when amperage is exceeded.

50. The method of claim 42, further including the step of transporting the gases to a pressure-equalizing unit.

51. The method of claim 50, further including the steps of bubbling the hydrogen and oxygen gases through water in the pressure-equalizing unit, and storing the hydrogen and oxygen gases in an upper portion of the pressure-equalizing unit.

52. The method of claim 50, wherein said injecting step further includes the step of using negative pressure to flow the hydrogen and oxygen gases to a combustion device.

53. The method of claim 52, wherein said injecting step further includes the step of creating suction in tubing connecting the pressure-equalizing unit to an air intake manifold.

54. The method of claim 53, wherein the combustion device is an internal combustion engine, and wherein said injecting step further includes the step of mixing the hydrogen and oxygen gases with atmospheric gases.

55. The method of claim 53, further including the step of temporarily raising a heat level in the combustion device.

56. The method of claim 53, wherein said step of using negative pressure is performed by operating an air compressor.

57. The method of claim 50, wherein said producing step further includes the step of controlling an amount of water distributed to the production unit and the pressure-equalizing unit.

58. The method of claim 50, wherein said electrolyzing step is performed in at least two production units, and the hydrogen and oxygen gases produced are gathered together before the step of transporting the gases to the pressure-equalizing unit.

59. The method of claim 50, wherein said injecting step further includes the step of injecting oxygen as an additive.

60. The method of claim 50, wherein said performing step is further defined as performing combustion on only the hydrogen and oxygen gases.

61. The method of claim 60, further including the step of collecting water vapor formed in said performing step.

62. The method of claim 61, further including the step of recycling the water vapor for use in said producing step.

63. The method of claim 50, further including the steps of sensing data about the producing step, collecting the data, and transmitting the data.

64. The method of claim 63, further including the step of calculating hydrogen and oxygen outputs.

65. The method of claim 64, further including the step of comparing the outputs to optimized results, and actuating control outputs for optimization.

66. A method of distributing current in an electrolysis system, including the steps of:
routing power from a current source with an electronic control system;
dedicating electricity for external demands;
dedicating electricity for hydrogen production;
controlling the proportion of hydrogen and oxygen produced;
supplying electricity for production of hydrogen and oxygen;
producing hydrogen and oxygen at an output chosen from the group consisting of fixed and variable;
storing the hydrogen and oxygen; and
feeding back results to the electronic control system.

67. The method of claim 66, wherein said dedicating electricity for hydrogen production step is accomplished by subtracting external demand electricity from the current source.

68. The method of claim 66, wherein said controlling step is performed according to quantities needed for a process chosen from the group consisting of combustion and enrichment.
